(19) United States
(12) Patent Application Publication
(10) Pub. No.: US 2024/0163778 A1
(43) Pub. Date: May 16, 2024

(54) USING SHARED CONTEXT TO BOOTSTRAP DEVICE DISCOVERY

(71) Applicant: Samsung Electronics Co., Ltd., Suwon-si (KR)

(72) Inventors: Bilal Sadiq, Plano, TX (US); Boon Loong Ng, Plano, TX (US)

(21) Appl. No.: 18/482,757

(22) Filed: Oct. 6, 2023

Related U.S. Application Data
(60) Provisional application No. 63/425,581, filed on Nov. 15, 2022.
(60) Provisional application No. 63/453,670, filed on Mar. 21, 2023.

(51) Int. Cl. H04W 48/16

(52) U.S. Cl. CPC H04W 48/16

(57) ABSTRACT

A method includes identifying, by a first device, a shared context for a specified discovery process including at least one of a first discovery process for the first device or a second discovery process for a second device. The method also includes determining, by the first device, one or more parameters of the first discovery process for the first device based on the shared context. The method further includes performing or resuming, by the first device, the first discovery process for the first device based on the one or more parameters.

### CROSS-REFERENCE TO RELATED APPLICATION(S) AND CLAIM OF PRIORITY

This application claims priority under 35 U.S.C. § 119(e) to U.S. Provisional Patent Application No. 63/425,581 filed on Nov. 15, 2022, and to U.S. Provisional Patent Application No. 63/453,670 filed on Mar. 21, 2023, both of which are hereby incorporated by reference in their entirety.

### TECHNICAL FIELD

This disclosure relates generally to wireless communications systems. Embodiments of this disclosure relate to methods and apparatuses for using shared context to bootstrap device to device discovery.

### BACKGROUND

Devices engaged in discovery typically access the communication medium, such as a shared wireless band, with some randomness in at least one of time, frequency, or code. For example, a device transmitting a discovery message may randomly select for transmission a wireless channel out of the multitude of available channels, may wait a random amount of time between retransmissions, and may hop to a different randomly selected channel for transmission after some time. Similarly, a device listening for a discovery message may not be capable of listening on all available channels simultaneously and thus may randomly select a channel to listen on, may listen for a random amount of time, and may hop to a different randomly selected channel after some time or may stop listening for a random amount of time.

### SUMMARY

Embodiments of the present disclosure provide methods and apparatuses for using shared context to bootstrap device to device discovery.

In one embodiment, a method includes identifying, by a first device, a shared context for a specified discovery process including at least one of a first discovery process for the first device or a second discovery process for a second device. The method also includes determining, by the first device, one or more parameters of the first discovery process for the first device based on the shared context. The method further includes performing or resuming, by the first device, the first discovery process for the first device based on the one or more parameters.

In another embodiment, a device includes a transceiver and a processor operably connected to the transceiver. The processor is configured to: identify a shared context for a specified discovery process including at least one of a first discovery process for the device or a second discovery process for a second device; determine one or more parameters of the first discovery process for the device based on the shared context; and perform or resume the first discovery process for the device based on the one or more parameters.

In another embodiment, a non-transitory computer readable medium includes program code that, when executed by a processor of a device, causes the device to: identify a shared context for a specified discovery process including at least one of a first discovery process for the device or a second discovery process for a second device; determine one or more parameters of the first discovery process for the device based on the shared context; and perform or resume the first discovery process for the device based on the one or more parameters.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example process for Neighbor Awareness Networking (NAN) Unsynchronized Service Discovery (USD);

FIG. 4 illustrates an example discovery process in which different types of information can be used as shared context according to various embodiments of the present disclosure;

FIG. 5 illustrates an example timeline of a USD publisher state showing a Guaranteed SCP Interval according to various embodiments of the present disclosure;

FIG. 6 illustrates a table that provides an example range of values supported for different discovery parameters, according to various embodiments of the present disclosure;

FIG. 7 illustrates a table that provides example length-type-value (LTV) data fields for loose synchronization, according to various embodiments of the present disclosure;

FIG. 8 illustrates another example discovery process in which different types of information can be used as shared context according to various embodiments of the present disclosure;

FIG. 9 illustrates further details of the discovery process of FIG. 8 according to various embodiments of the present disclosure;

FIGS. 10 through 13 illustrate example processes for using shared context in device to device discovery according to various embodiments of the present disclosure;

FIG. 14 illustrates a chart showing a comparison of default parameters of a publisher as predicted by a subscriber according to various embodiments of the present disclosure; and

FIG. 15 illustrates a flowchart of a method for using shared context to bootstrap device to device discovery according to various embodiments of the present disclosure.

### DETAILED DESCRIPTION

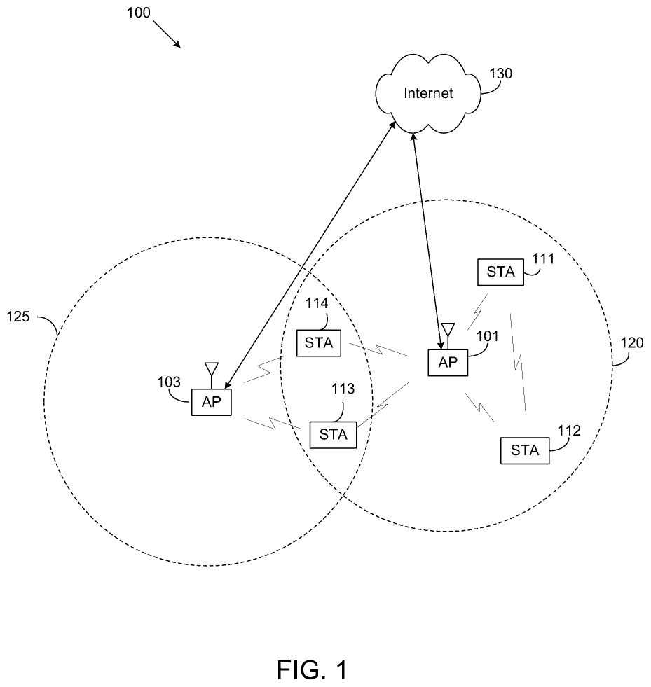

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN (wireless local area network) communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming to enable using shared context to bootstrap device to device discovery. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provide STAs with direct wireless broadband access to the network 130. Further, the APs 101 and/or 103 could provide access to other or additional external networks, such as external telephone networks or other types of data networks.

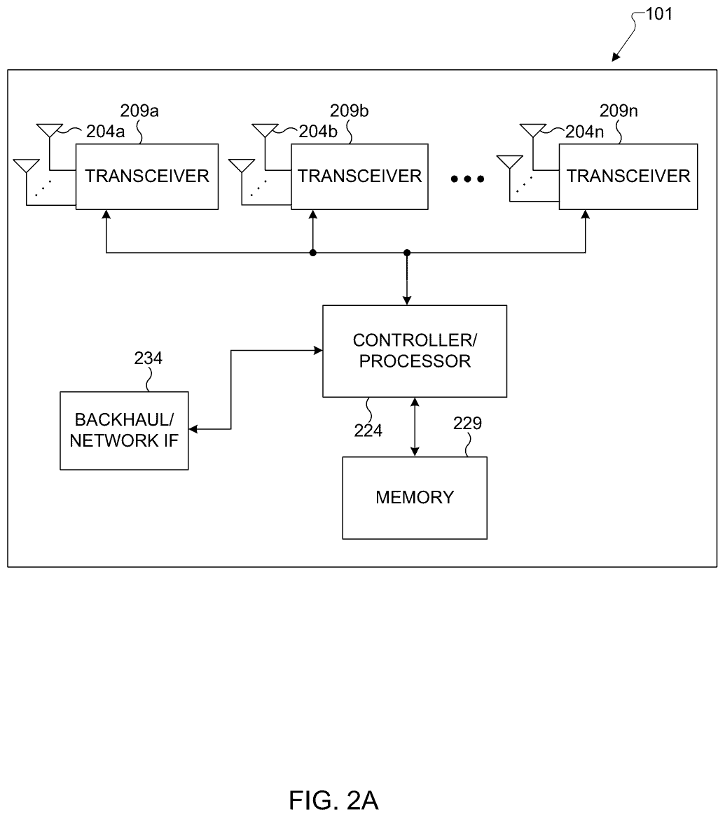

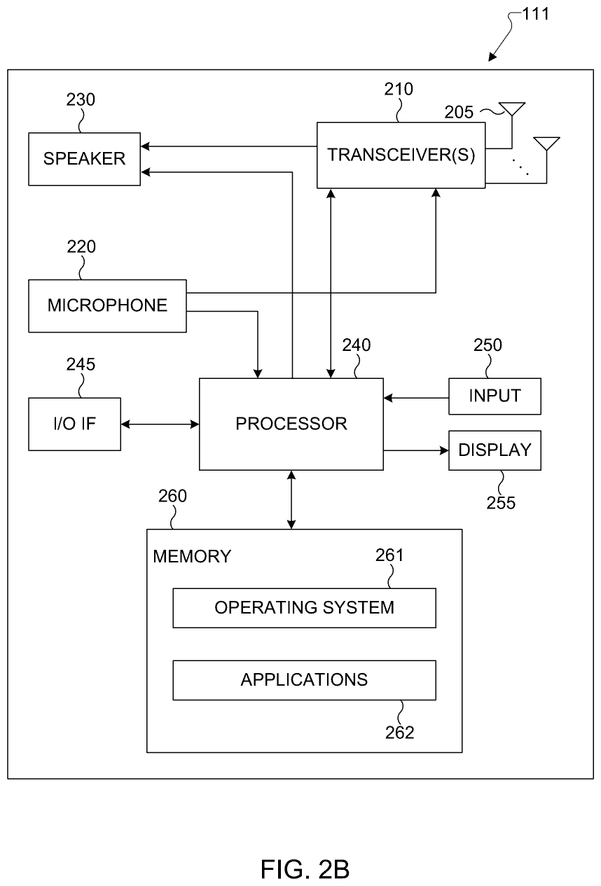

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including enabling the use of shared context to bootstrap device to device discovery. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for enabling the use of shared context to bootstrap device to device discovery. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 112-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to enable using shared context to bootstrap device to device discovery. In some embodiments, the processor 240 includes at least one microprocessor or microcontroller.

The processor 240 is also capable of executing other processes and programs resident in the memory 260, such as operations for enabling the use of shared context to bootstrap device to device discovery. The processor 240 can move data into or out of the memory 260 as required by an executing process. In some embodiments, the processor 240 is configured to execute a plurality of applications 262, such as applications to enable the use of shared context to bootstrap device to device discovery. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As previously noted, devices engaged in discovery typically access the communication medium, such as a shared wireless band, with some randomness in at least one of time, frequency, or code. For example, a device transmitting a discovery message may randomly select for transmission a wireless channel out of the multitude of available channels, may wait a random amount of time between retransmissions, and may hop to a different randomly selected channel for transmission after some time. Similarly, a device listening for a discovery message may not be capable of listening on all available channels simultaneously and thus may randomly select a channel to listen on, may listen for a random amount of time, and may hop to a different randomly selected channel after some time or may stop listening for a random amount of time. These instances of random actions can present challenges for the transmitting device and the listening device to discover each other.

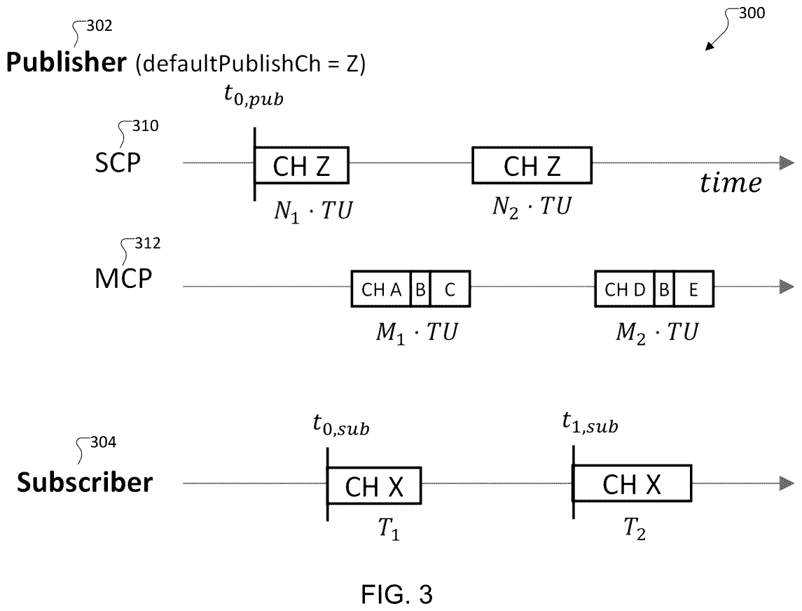

For example, FIG. 3 illustrates an example process 300 for Neighbor Awareness Networking (NAN) Unsynchronized Service Discovery (USD). As shown in FIG. 3, a publisher device 302 performs state and channel hopping to meet a subscriber device 304 on the channel and time where the subscriber device 304 is listening. The publisher device 302 and the subscriber device 304 start their respective USD operations independently. The process 300 may be triggered by an application or user interaction on each device 302 and 304. In general, the trigger is not synchronized across the two devices 302 and 304, and the devices 302 and 304 are not synchronized (i.e., do not have a common time reference accurate to a few milliseconds.)

The publisher device 302 enters the Single Channel Publish (SCP) state 310, selects the configured default channel (channel Z) and dwells there for a random length of time N₁·TU (time units), transmitting one or more publish messages and listening for a subscribe message sent by any subscriber device.

In the event that the publisher device 302 does not detect a subscribe message leading to a successful conclusion of USD, the publisher device 302 enters the Multiple Channels Publish (MCP) state 312 and dwells there for a random length of time M₁·TU, and further randomly subdivides this dwell time among a randomly selected subset of channels, sequentially transmitting one or more publish messages and listening for a subscribe message on each channel in the random subset.

If USD still does not conclude successfully, the publisher device 302 then re-enters the SCP state 310 for a random dwell time N₂·TU. Unless USD concludes successfully, the publisher device 302 then re-enters the MCP state 312 with another set of randomly drawn configuration of channels. The process 300 continues until success or a time out. Before terminating the process 300 due to time out, the publisher device 302 is expected to have transmitted a publish message and listened for a subscribe message on each channel of the supported band for at least a minimum required time (e.g., 100 ms).

During the process 300, the subscriber device 304 selects a channel to listen on (channel X) for a publish message and may listen on the channel intermittently. Both the channel and the duration of each dwell interval on the channel may be determined randomly or based on constraints from other ongoing Wi-Fi operations the subscriber device 304 is engaged in.

In general, the subscriber device 304 does not have any information about the random draw of parameters being used by the publisher device 302, such as the fine start time of USD t_{0,pub} by the publisher device 302, channel order in MCP state and the dwell times on various channels. Likewise, the publisher device 302 in general has no information about the subscriber device 304's selection of channel or dwell intervals. However, if the subscriber device 304 could predict at least some parameters being used by the publisher device 302, the subscriber device 304 could adopt a subscriber strategy (e.g., dwell interval and channel) that offer better performance such as lower latency, higher likelihood of success, and/or lower power consumption by one or both devices.

To address these and other issues, this disclosure provides systems and methods for using shared context to bootstrap device to device discovery. As described in more detail below, the disclosed embodiments improve discovery of nearby devices (and/or the services made available by nearby devices) by opportunistically making the behavior of a device at least partially predictable for its peer devices. The peer devices may then employ a strategy informed by the predicted behavior of the first device to improve a desired performance metric. A device achieves this effect by determining at least a part of its otherwise unpredictable behavior based on certain information it acquires from the environment, where the other nearby devices may also independently acquire the same information from the environment.

Note that while some of the embodiments discussed below are described in the context of WiFi NAN discovery, these are merely examples. It will be understood that the principles of this disclosure may be implemented in any number of other suitable contexts or systems, including Bluetooth and LTE sidelink.

To promote understanding of the disclosed embodiments, it may be helpful to first define shared context. As used herein, shared context is any information (e.g., as little as a few bits, or more) that is either previously known to both the devices engaged in discovery (e.g., through a previous recent communication) or can be independently learned from the environment without first communicating with each other.

As an example of previously known information serving as shared context, consider a specific example use case, before the start of USD, in which a message is exchanged over Bluetooth Low Energy (BLE) between the two devices (e.g., an advertisement message broadcasted by one device and received by the other). In such a case, that message (or a part of it) can be considered as shared context between the two devices. Moreover, the time instant of transmission or reception of the message is another example of shared context, providing a common timing event between the nearby devices.

As an example of information independently learned from the environment serving as shared context, consider the following: A device may learn from its environment the SSID of the Wi-Fi Access Point (AP) on a channel (e.g., channel 6 or another predetermined or preconfigured channel) that has the strongest signal strength at this device's location. If two devices that are sufficiently close perform this measurement independently, they will likely learn the same SSID. So, the “SSID of the Strongest detected Wi-Fi AP on channel 6” is an example of the shared context that can be learned from the environment independently by the two devices. Additionally, or alternatively, the MAC address or other identifiers for the Wi-Fi AP can also be used as a shared context. Moreover, the periodic beacon transmission times of this strongest AP is another example of shared context providing common timing events between the nearby devices. More generally, a device can compile a list of three strongest Wi-Fi APs measured at its location, and the list compiled by nearby devices will likely have some overlap. Such a list along with the beacon transmission times of each AP in the list is an example of shared context. Another non-RF example of shared context, applicable for some use cases for devices equipped with microphones, is the ambient acoustic noise level or another acoustic signature learned from listening to the environment.

Further to the notion of shared context, it is noted that, by nature, many measurable physical properties are correlated over space and time. So, in general, any awareness of the environment and environmental properties (e.g., ambient air temperature or the like) by the devices engaged in proximity-based services amounts to having mutual information between those devices. Information that may be most useful for this purpose may include the knowledge of physical properties that are highly correlated up to the distances over which discovery takes place but decorrelate quickly beyond those distances. Similarly, as for correlation over time of these physical properties, most useful may be the properties that are highly correlated over the time span during which the two devices independently measure them (e.g., based on a trigger received from an application or user interaction to start discovery), but then decorrelate quickly over longer time spans. Note that, in some cases, the correlation over the distance and time span is necessary for the shared context to be shared by the devices; however, decorrelation for larger distances and time spans is merely desirable.

Other examples exist of shared context specific to certain use cases or scenarios. For example, consider a use case of initiating USD for sharing a home Wi-Fi password with a visiting guest. One may prefer to convey the password directly from the homeowner to the guest for various reasons such as complexity of accurately conveying an alphanumeric password, mis-remembering, privacy, or slowness of verbal communication and typing. Also, for security reasons, the homeowner may prefer to share the password over a direct device-to-device link, instead of sharing it through a message over the interne. The guest's device can scan for available Wi-Fi networks, and the homeowner can inform the guest which SSID appearing in the list is their home network. Therefore, this SSID perhaps communicated verbally as well as the beacon transmission times, and the channel of the home AP readily learned over the air can be considered as shared context for this use case.

In other use cases, shared context may be defined by detecting a specific appliance type (e.g., a TV by a specific vendor) over the air, and defining radio transmission attributes such as advertised name, transmission time and channel learned from detecting the appliance.

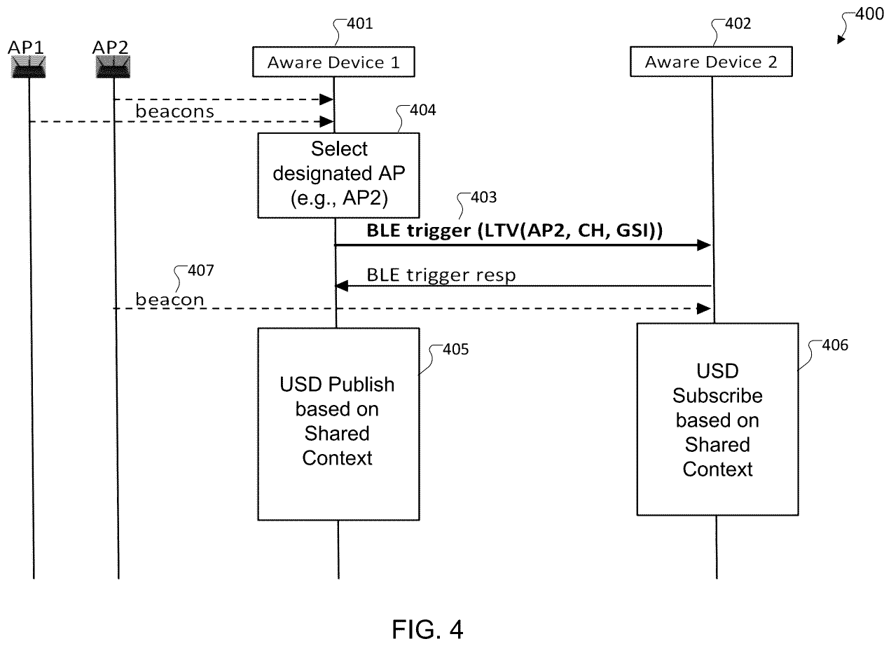

In another example, shared context may comprise both types of elements discussed above: previously known information as well as information independently learned from the environment. This is illustrated in an example in FIG. 4.

FIG. 4 illustrates an example discovery process 400 in which different types of information can be used as shared context according to various embodiments of the present disclosure. As shown in FIG. 4, two devices—a publishing device 401 and a subscribing device 402—perform the discovery process 400 using shared context information. Each of the devices 401 and 402 can represent (or be represented by) one of the components of the wireless network 100 (e.g., the STA 111).

Initially, the publishing device 401 can send a prior message, such as a BLE advertisement trigger message 403. One portion of shared context used in the discovery process 400 can include information exchanged between the devices 401 and 402 in the BLE advertisement trigger message 403, such as an indication of a designated AP and possibly selected parameters associated with discovery. A second portion of shared context can include information acquired from the environment directly, such as a shared timing reference acquired by all devices directly from the indicated designated AP. In some embodiments, the publishing device 401 may perform one or more of the following:
(1) Before sending the BLE advertisement trigger message 403, the publishing device 401 may select (or is provided) a designated AP 404. This may be an AP that the publishing device 401 is already connected to (e.g., AP2), or an AP meeting a certain designation criterion. The designated criterion may be as previously discussed: an AP meeting a detected signal strength criterion (e.g., a RSSI greater than a threshold or a highest RSSI among detected APs), or an AP on a specific channel (e.g., a Default Publish Channel) that meets a further signal strength criterion. The publishing device 401 may start a local reference clock—the time according to which is denoted t TUs subsequently—synchronized to the timestamp in a beacon of the designated AP 404.
(2) The publishing device 401 may select one or more parameters associated with the discovery process 400, such as a period T_{period} TUs parameter and an offset T_{offset} TUs parameter.
(3) During the discovery process 400, the publishing device 401 may perform a USD Publish operation 405. During the USD Publish operation 405, the publishing device 401 may perform a certain preconfigured operation based on the parameters and the reference timing acquired from the designated AP 404. For example, the publishing device 401 may perform the USD Publish operation 405 at least on a specific channel for at least a specific interval starting at one or more specific times. For example, the publishing device 401 may operate in a SCP state at least for any time t TUs that satisfies:

mod(t−t_{min_scp}, T_{period})=T_{offset}, ∀t_{min_scp}∈[0, N₁×100 TUs]

where N₁ may be a preconfigured parameter such as an indication of minimum dwell time in SCP.

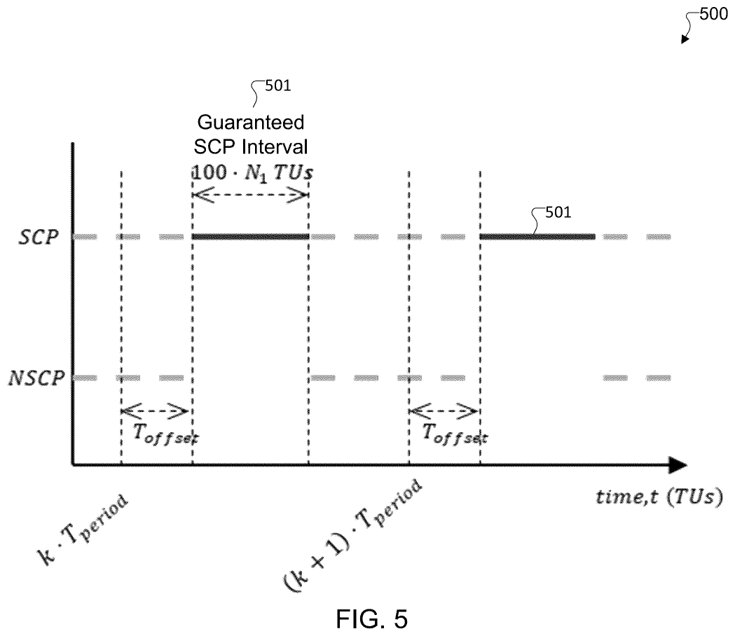

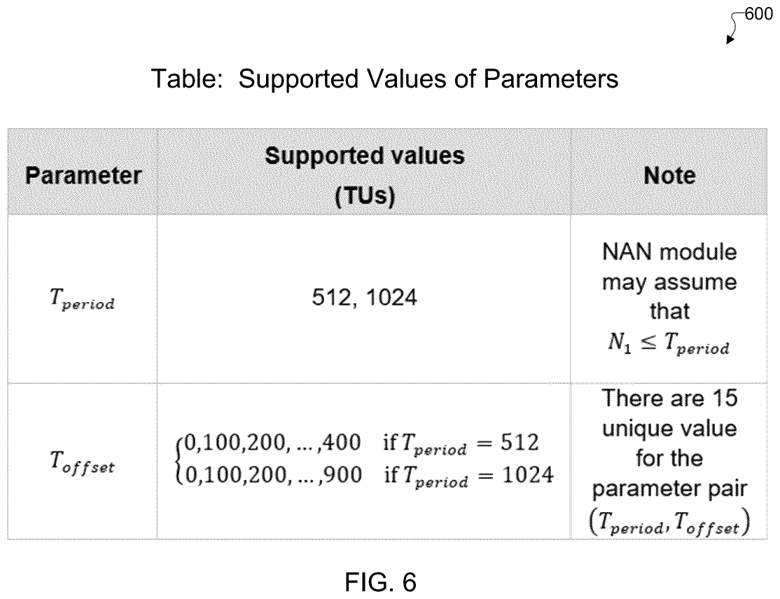

The USD Publish operation 405 may operate in SCP for at least N₁×100 TUs starting at any time t=T_{offset}(mod T_{period}). This time interval may be referred to as the Guaranteed SCP Interval. FIG. 5 illustrates an example timeline 500 of the USD publisher state showing a Guaranteed SCP Interval 501 according to various embodiments of the present disclosure. As shown in FIG. 5, the Guaranteed SCP Interval 501 occurs during every period T_{period} after the offset T_{offset}. It is noted that the USD Publish operation 405 may be in SCP at other times too, e.g., slightly preceding the time t=T_{offset}(mod T_{period}) or slightly longer than N₁×100 TUs after time t=T_{offset}(mod T_{period}). So, the USD Publish operation 405 may enter SCP before time t=T_{offset}(mod T_{period}), but as a predictable behavior, may be guaranteed to remain in SCP for another N₁×100 TUs after the time t=T_{offset}(mod T_{period}). This is illustrated in FIG. 5. FIG. 6 illustrates a table 600 that provides an example range of values supported for parameters T_{period} and T_{offset}, according to various embodiments of the present disclosure. Of course, the values shown in the table 600 are examples only; other values may be possible.

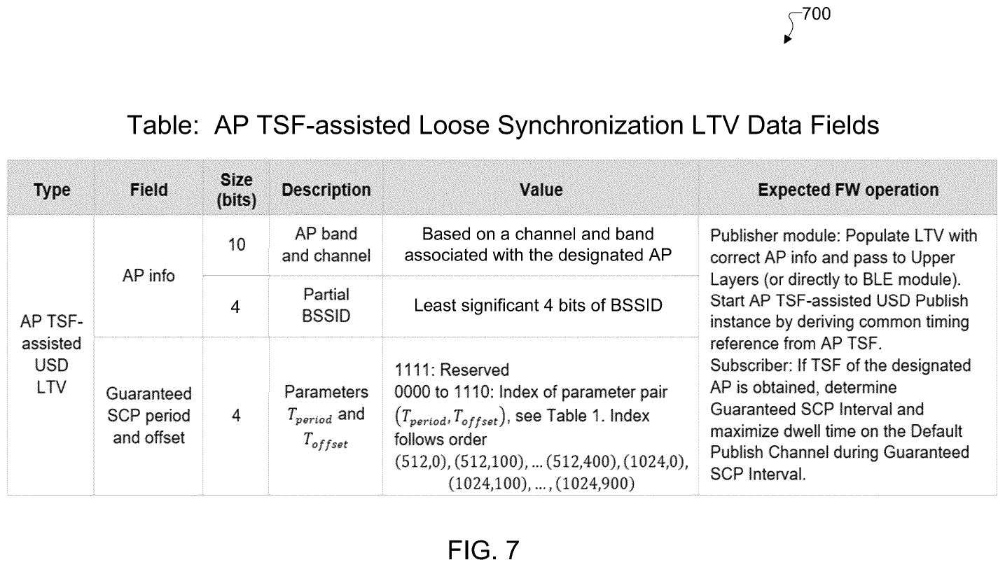

FIG. 7 illustrates a table 700 that provides example length-type-value (LTV) data fields for loose synchronization, according to various embodiments of the present disclosure. As shown in table 700, four bits in LTV convey the parameters T_{period} and T_{offset}, which determine the occurrence of the Guaranteed SCP Interval 501 per the TSF of the designated AP 404. Of course, the values shown in the table 700 are examples only; other values may be possible.

To reduce implementation complexity, the publishing device 401 may be permitted a generous timing error (e.g., +/−5 TUs) in the reference clock or in the start and the end of the Guaranteed SCP Interval 501. This may be because, if the guaranteed SCP state is 256 TUs long, an error of +/−5 TUs in predicting its start or end by the subscribing device 402 may result in only minor performance loss.
(4) The publishing device 401 may send an indication of the designated AP 404 in the BLE advertisement trigger message 403. Indication of the designated AP 404 may include one or more of a band and a channel where the designated AP 404 is operating, or at least a partial identification such as BSSID associated with the designated AP. In some embodiments, the indication may comprise only the four least significant bits of the BSSID of the designated AP 404.
(5) The publishing device 401 may send in the BLE advertisement trigger message 403 an indication of the parameters associated with the discovery process 400, such as the parameters T_{period} and T_{offset}. The BLE advertisement trigger message 403 may include, e.g., 10 bits to indicate the band and the channel, 4 bits to indicate the partial identification, and 4 bits to indicate the pair of parameters (T_{period}, T_{offset}).
(6) The publishing device 401 may retransmit the BLE advertisement trigger message 403 or at least a part of information in the BLE advertisement trigger message 403, one or more times before or during the discovery process 400.
(7) While selecting the designated AP 404, the publishing device 401 may avoid selecting an AP as the designated AP 404 if the four least significant BSSID bits of this AP match those of another detected AP on the same channel and band. More generally, the publishing device 401 may avoid selecting an AP as the designated AP 404 if the publishing device 401 can determine that the AP may not be uniquely identified based on the indication of the AP in the BLE advertisement trigger message 403.

The subscribing device 402 may receive the BLE advertisement trigger message 403 or the retransmission and enter into a USD Subscribe operation 406. In some embodiments, the subscribing device 402 may perform one or more of the following:
(1) The subscribing device 402 may obtain the indication of the designated AP 404 from the BLE advertisement trigger message 403. The subscribing device 402 may identify the designated AP 404 and acquire a reference time from the designated AP 404. For example, the reference time may be the timestamp in a received beacon transmission 407 of the designated AP 404 or a timestamp in the probe response from the designated AP 404. The subscribing device 402 may establish a common timing reference with the publishing device 401 based on the time acquired from the designated AP 404. In some cases (e.g., where the Wi-Fi module of the subscribing device 402 is already connected to the designated AP 404), the Wi-Fi module may already have acquired the timestamp from the designated AP 404 and therefore the USD Subscribe operation 406 may establish the common timing reference immediately. In other cases (e.g., when the designated AP 404 is broadcasting beacons on the Default Publish Channel), the subscribing device 402 may start the USD Subscribe operation 406 without a common timing reference, and opportunistically acquire the timestamp from the designated AP 404 on the fly, and then establish the common timing reference.
(2) The subscribing device 402 may obtain one or more parameters associated with the discovery process 400 from the BLE advertisement trigger message 403.
(3) The subscribing device 402 may start the USD Subscribe operation 406 immediately, e.g., without first acquiring the timestamp from the designated AP 404's beacon transmission 407 to establish a common timing reference.
(4) Once the subscribing device 402 has established the common timing reference, the subscribing device 402 may determine one or more steps of its part of the discovery process 400 based on the common timing reference and the parameters received in the BLE advertisement trigger message 403. For example, the subscribing device 402 may do one or more of the following:

During the Guaranteed SCP Interval 501, the subscribing device 402 may scan the Default Publish Channel as much as possible. For example, if the subscribing device 402 is connected to an AP on a different channel than the Default Publish Channel, the subscribing device 402 may scan the Default Publish Channel with 50% duty cycle with the AP channel. Or if the subscribing device 402 has no other ongoing operation, the subscribing device 402 may scan the Default Publish Channel with 100% duty cycle. In addition to adjusting the duty cycle, the subscribing device 402 can attempt to start scanning the Default Publish Channel coinciding with the start of the Guaranteed SCP Interval 501.

Outside of the Guaranteed SCP Interval 501, the subscribing device 402 may treat the USD Subscribe operation 406 with a lowest priority. For example, the Wi-Fi module of the subscribing device 402 would stay on the AP channel or the channel of any other ongoing activity.

As discussed above, a portion of shared context (e.g., an indication of the designated AP 404 and associated parameters) can be determined using a prior message, such as the BLE advertisement trigger message 403. Another portion of shared context (e.g., the common timing reference) can be acquired directly from the environment. Next, it will be explained how shared context, where available, can be used to make a device's behavior at least partially predictable to other nearby devices, in a way that can help the other devices employ a better search strategy. In the discussion below, the device may be a publishing device 401 engaged in a Discovery Publish operation, a subscribing device 402 engaged in a Discovery Subscribe operation, or any other suitable device. In some embodiments, the device may start a discovery process and then modify the procedure on-the-fly after the device has acquired shared context.

A device identifies a shared context and determines at least a part of its discovery process based on the shared context. The device may be preconfigured to identify or select the shared context based on the use case or application. For example, for a password sharing application, the device may be preconfigured to use certain attributes of the home Wi-Fi network.

The determining of at least a part of the discovery process may also be performed in a preconfigured manner based on a preconfiguration of the device. In such cases, the preconfiguration provides a function to map shared context to one or more parameters used for the discovery process. For example, in some embodiments, all devices from a certain vendor can have the same preconfiguration. Therefore, by acquiring shared context from the environment, the devices use their preconfiguration to determine at least a part of their discovery process. As explained in greater detail below, it is this preconfiguration (e.g., written in firmware at manufacturing) along with the shared context (e.g., acquired from the environment at runtime) that enables subscribing devices to predict at least some parts of the publishing device's discovery behavior.

In some embodiments, any one or more of the following parts of the discovery process may be determined using shared context:
(1) The start time of USD may be anchored to a timing event in shared context. For example, the start time may occur after a preconfigured offset (e.g., 20 ms) from the timing event. As a particular example, the timing event in shared context may be the beacon transmission time of a specific AP.
(2) The device may anchor a dwell interval on a specific channel to a timing event in the shared context. The specific channel may be preconfigured (e.g., channel 6) or determined based on other attributes of the shared context. As a particular example, the device may dwell on channel 6 with a 20 ms offset every 4 th timing event.
(3) More generally, a time of one or more events of the discovery process may be determined based on a time reference in the shared context.
(4) The device may determine a default channel based on the shared context.
(5) The device may determine an order of channels (e.g., an order in which to sequentially dwell on channels) based on the shared context. For example, out of K available permutations of all channels, where the K permutations are enumerated in lexicographic order, the device selects the permutation number mod(SSID, K), where the bitstring SSID is treated as a number.
(6) The device may determine a subset of entries in the channel order list based on one information element in the shared context, and a different subset based on a different information element in the shared context. As an example, the 1st, 4th, 7th, etc. entries are determined by SSID1; while the 2nd, 5th, 8th, etc. entries are determined by SSID2; and the 3rd, 6th, 9th, etc. entries are determined randomly from the remaining channels.
(7) The device may determine the dwell time on one or more channels based on the shared context.
(8) The device may determine the sequence of dwell times based on the shared context (e.g., the dwell times occur in this order: [100 ms, 400 ms, 200 ms, 400 ms, . . . ]).
(9) Probabilistic determination: “Determine” above includes determining a non-uniform distribution from which to draw the value of the quantity. Therefore, the shared context would have the effect of making certain values more likely to be selected by the device than other values.

In some embodiments, a device may further determine its discovery process indirectly based on the shared context as follows: The device determines its discovery process based on a predicted behavior of another device that uses the shared context in a preconfigured way. For example, a USD Subscriber device (e.g., the subscribing device 402) may be engaged in other ongoing Wi-Fi operations. Based on the constraints from those operations, the USD Subscriber device may identify a free interval (e.g., 250 ms) where it can listen for Publish messages on any channel. Then the USD Subscriber device can determine the channel based on the shared context in the following way: The USD Subscriber device may first predict the USD Publisher device's behavior in this shared context assuming that the USD Publisher device is using the shared context in the preconfigured manner. The USD Subscriber device can then determine for each channel the likelihood that the USD Publisher device will be transmitting Publish message on that channel during the free interval. The USD Subscriber device may then select a channel that has a high likelihood of Publish message detection. More generally, the USD Subscriber device may determine its dwell interval and channel jointly based on the predicted behavior of a USD Publisher device that uses shared context in a preconfigured manner.

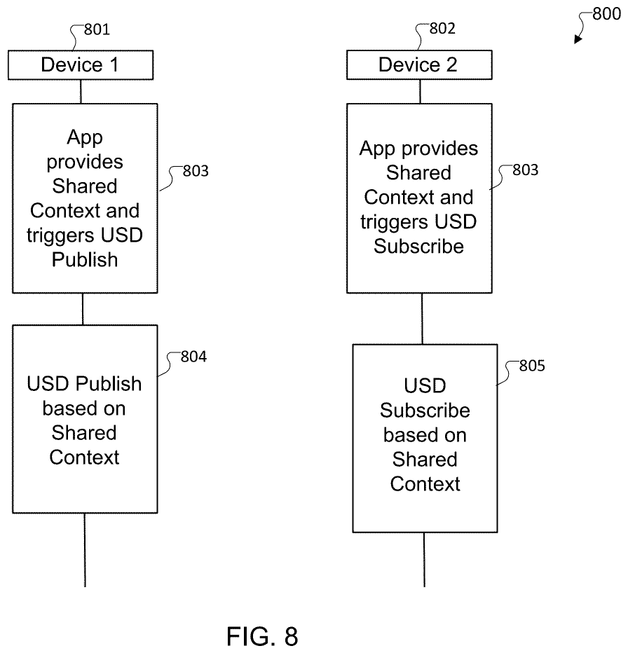

FIG. 8 illustrates another example discovery process 800 in which different types of information can be used as shared context according to various embodiments of the present disclosure. As shown in FIG. 8, two devices—a publishing device 801 and a subscribing device 802—perform the discovery process 800 using shared context information. In this example, an application layer process may provide the shared context for both devices 801 and 802 to trigger the discovery process 800, as indicated at 803. Some particular examples here include (i) home Wi-Fi password sharing with a visiting guest (where the home Wi-Fi SSID can be known by the application layer based on user input), (ii) a seed for a random number generator (for selecting USD parameters) between devices logged into same account, and (iii) using a cellular network time as a common reference when the use case permits. In some embodiments, the discovery process 800 is a USD discovery process, and the publishing device 801 performs a USD Publish operation 804 based on the shared context, while the subscribing device 802 performs a USD Subscribe operation 805 based on the shared context.

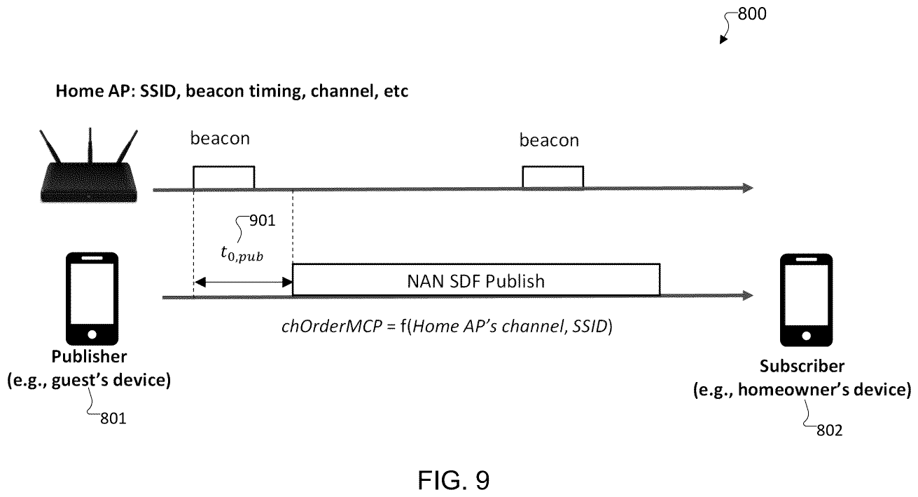

FIG. 9 illustrates further details of the discovery process 800 according to various embodiments of the present disclosure. As shown in FIG. 9, the discovery process 800 is for an example of a user sharing a home Wi-Fi password with a visiting guest. For this example, the shared context for this service can be one or more broadcast parameters of the targeted home Wi-Fi network, such as SSID, beacon timing, channel, and the like. The service layers on both the publishing device 801 and the subscribing device 802 have access to this context.

During the discovery process 800, the publishing device 801 can anchor the t_{0,pub} event 901 to the beacon timing from the target SSID. Alternatively, the publishing device 801 could anchor a different event instead of the t_{0,pub} event 901. The publishing device 801 can also determine a partial MCP channel order and dwell times as a function of the home AP' s channel and SSID. Knowing the behavior of the publishing device 801 in this context, the subscribing device 802 can select its reception channel and time, e.g., taking into account its dwell time constraints from other Wi-Fi operations (if any).

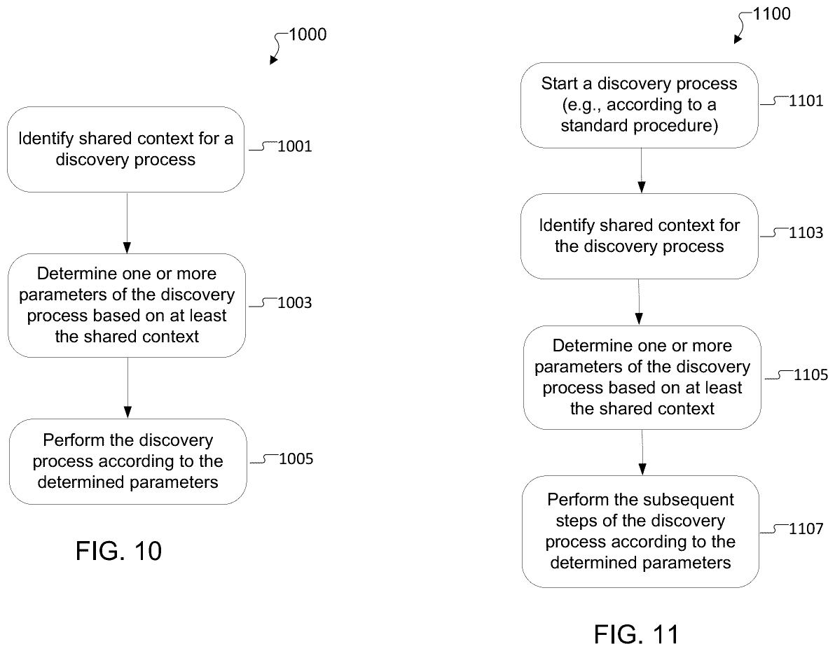

FIGS. 10 and 11 illustrate example processes 1000 and 1100 for using shared context in device to device discovery according to various embodiments of the present disclosure. As shown in FIG. 10, the process 1000 starts with step 1001, in which a device (e.g., the publishing device 401 or the subscribing device 402) first identifies the shared context for the discovery process. At step 1003, the device determines one or more parameters of the discovery process based on the identified shared context. At step 1005, the device then performs the discovery process according to the determined parameters.

As shown in FIG. 11, the process 1100 starts with step 1101, in which a device (e.g., the publishing device 401 or the subscribing device 402) goes ahead and starts the discovery process according to a standard procedure, since the shared context may take some time to acquire. Once the device starts the discovery process, the device also works on acquiring shared context at step 1103. Once the shared context is acquired, at step 1105, the device determines one or more parameters of the discovery process based on the identified shared context. At step 1107, the device then performs the remaining steps of the discovery process according to the determined parameters.

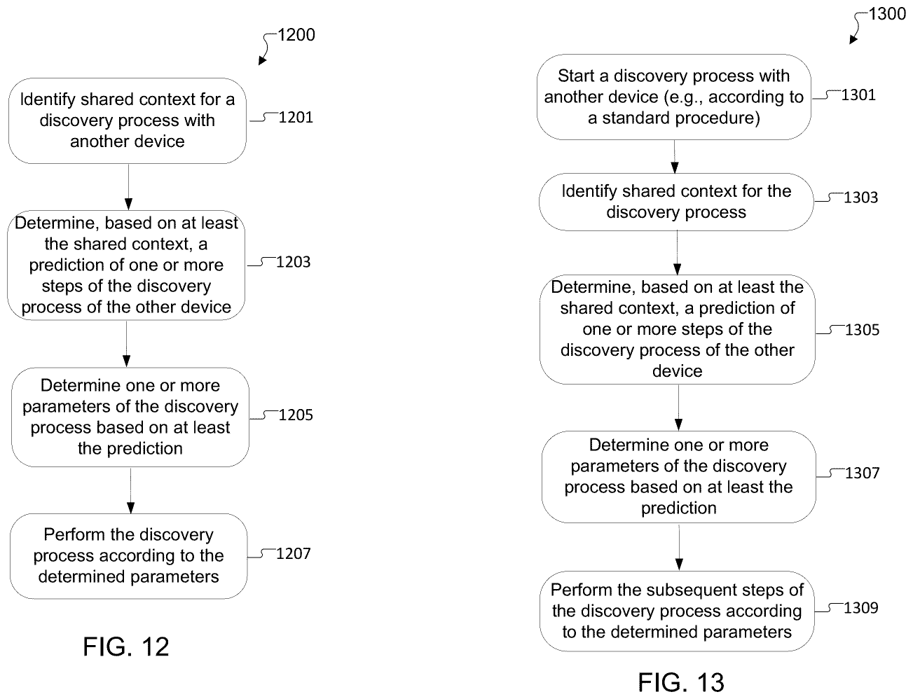

FIGS. 12 and 13 illustrate other example processes 1200 and 1300 for using shared context in device to device discovery according to various embodiments of the present disclosure. FIGS. 12 and 13 illustrate that the device may use shared context indirectly to determine the steps of its discovery process. Specifically, the device (referred to as a first device) may use shared context to predict the behavior of a second device (possibly a fictitious device) that uses the shared context in a preconfigured manner to determine its (i.e., the second device's own) discovery process. Then the first device determines the steps of its own discovery process based on the predicted behavior of the second device (where the prediction in turn was based on the shared context).

As shown in FIG. 12, the process 1200 starts with step 1201, in which a device identified shared context for a discovery process with another device. At step 1203, the device determines, based on the shared context, a prediction of one or more steps of the discovery process of the other device. At step 1205, the device determines one or more parameters of its own discovery process based on the prediction. At step 1207, the device then performs its discovery process according to the determined parameters.

As shown in FIG. 13, the process 1300 starts with step 1301, in which a device starts a discovery process with another device according to a standard procedure, since the shared context may take some time to acquire. At step 1303, the device identifies the shared context for the discovery process. At step 1305, the device determines, based on the shared context, a prediction of one or more steps of the discovery process of the other device. At step 1307, the device determines one or more parameters of its own discovery process based on the prediction. At step 1309, the device then performs the remaining steps of its discovery process according to the determined parameters.

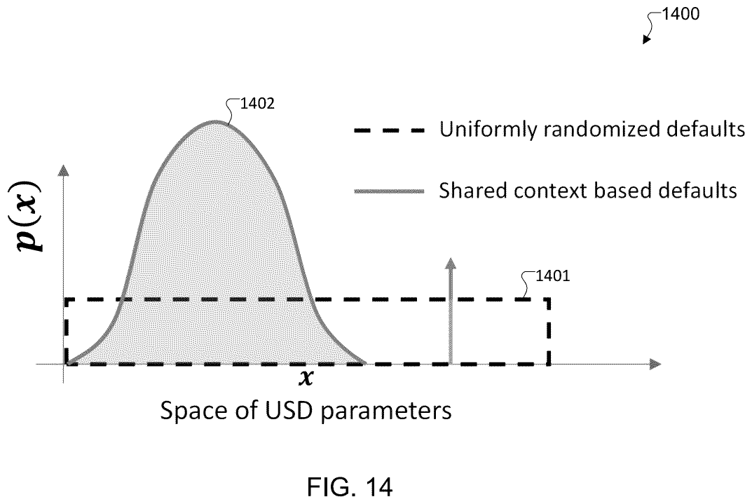

The embodiments described above use shared context directly in a preconfigured manner to determine one or more steps of a discovery process for a device. More generally, the disclosed embodiments induce a non-uniform probability distribution on the publishing device's behavior in time and over channels (i.e., add conditional predictability). The subscribing device then optimizes its search strategy for this non-uniform distribution. For example, FIG. 14 illustrates a chart 1400 showing a comparison of default parameters of the publisher as predicted by the subscriber according to various embodiments of the present disclosure. The distribution 1401 is a uniformly randomized distribution of default USD parameters of the publisher that may be predicted by the subscriber when the subscriber does not take into account any shared context with the publisher. The distribution is uniformly random (i.e., high entropy) because the behavior of the publisher cannot be predicted by the subscriber other than by random guess.

In contrast, the distribution 1402 shows a relatively more predictable form (e.g., lower entropy) of the publisher's default USD parameters based on shared context. For example, the distribution 1402 is concentrated on a reduced set of possible values for the USD parameters. In this case, the subscriber uses the determined shared context to more accurately predict the behavior of the publisher. In other words, the shared context reduces the randomness of determining (or predicting) the behavior of the publisher (e.g., a dwell time or a channel frequency used by the publisher, or any other suitable parameter) in the discovery process. Thus, the likelihood of the discovery process being successful is increased.

Although FIGS. 4 through 14 illustrate example techniques for using shared context in device to device discovery and related details, various changes may be made to FIGS. 4 through 14. For example, various components in FIGS. 4 through 14 could be combined, further subdivided, or omitted and additional components could be added according to particular needs. In addition, while shown as a series of steps, various operations in FIGS. 4 through 14 could overlap, occur in parallel, occur in a different order, or occur any number of times. In another example, steps may be omitted or replaced by other steps.

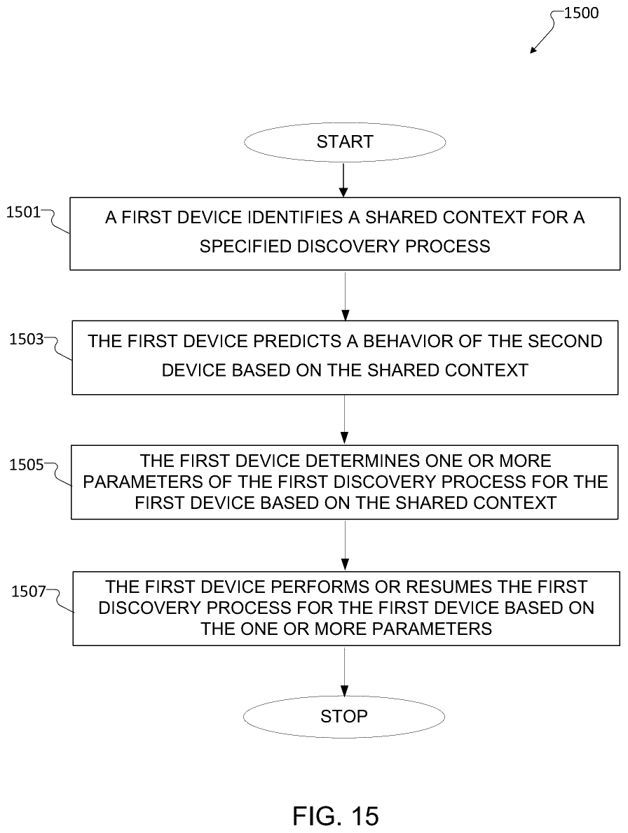

FIG. 15 illustrates a flow chart of a method 1500 for using shared context to bootstrap device to device discovery according to various embodiments of the present disclosure, as may be performed by the publishing device 401 or the subscribing device 402 (which can represent one or more components of the wireless network 100 (e.g., the STA 111)). The embodiment of the method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

As illustrated in FIG. 15, the method 1500 begins at step 1501. At step 1501, a first device identifies a shared context for a specified discovery process including at least one of a first discovery process for the first device or a second discovery process for a second device. This could include, for example, the publishing device 401 or the subscribing device 402 identifying a shared context for its discovery process or the discovery process of the other device, such as described in FIG. 4 and subsequent figures.

At step 1503, the first device predicts a behavior of the second device based on the shared context. The shared context is used by the second device in a preconfigured manner to determine the second discovery process. This step can be performed when the specified discovery process is the second discovery process for the second device. This could include, for example, the subscribing device 402 predicting a behavior of the publishing device 401, such as described in FIG. 4 and subsequent figures.

At step 1505, the first device determines one or more parameters of the first discovery process for the first device based on the shared context. In some embodiments, the one or more parameters of the first discovery process are determined by the first device based on the predicted behavior of the second device. This could include, for example, the subscribing device 402 determining one or more parameters for its discovery process based on the shared context, such as described in FIG. 4 and subsequent figures.

At step 1507, the first device performs or resumes the first discovery process for the first device based on the one or more parameters. This could include, for example, the subscribing device 402 performing or resuming its discovery process based on the determined parameters, such as described in FIG. 4 and subsequent figures.

Although FIG. 15 illustrates one example of a method 1500 for using shared context to bootstrap device to device discovery, various changes may be made to FIG. 15. For example, while shown as a series of steps, various steps in FIG. 15 could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
identifying, by a first device, a shared context for a specified discovery process including at least one of a first discovery process for the first device or a second discovery process for a second device;
determining, by the first device, one or more parameters of the first discovery process for the first device based on the shared context; and
performing or resuming, by the first device, the first discovery process for the first device based on the one or more parameters.

2. The method of claim 1, wherein the specified discovery process is the first discovery process for the first device.

3. The method of claim 1, wherein:
the specified discovery process is the second discovery process for the second device;
the method further comprises predicting, by the first device, a behavior of the second device based on the shared context, wherein the shared context is used by the second device in a preconfigured manner to determine the second discovery process; and
the one or more parameters of the first discovery process are determined by the first device based on the predicted behavior of the second device.

4. The method of claim 1, wherein the shared context reduces randomness of determining at least one of a dwell time or a channel frequency in the specified discovery process, such that a likelihood of the specified discovery process being successful is increased.

5. The method of claim 1, wherein the shared context comprises at least one of:
an SSID of a Wi-Fi access point in a vicinity of the first and second device;
a channel of the Wi-Fi access point in the vicinity of the first and second device; and
a Bluetooth Low Energy (BLE) trigger transmitted by the first device before the specified discovery process and containing a guaranteed Single Channel Publish (SCP) interval of the first device.

6. The method of claim 1, wherein the shared context is provided by a common application executing on both the first device and the second device.

7. The method of claim 6, wherein the shared context comprises at least one of:
one or more broadcast parameters of a local Wi-Fi network;
a seed for a random number generator; and
a cellular network time.

8. The method of claim 1, wherein the specified discovery process comprises a Neighbor Awareness Networking (NAN) Unxynchronized Service Discovery (USD) process.

9. A device comprising:
a transceiver; and
a processor operably connected to the transceiver, the processor configured to:
identify a shared context for a specified discovery process including at least one of a first discovery process for the device or a second discovery process for a second device;
determine one or more parameters of the first discovery process for the device based on the shared context; and
perform or resume the first discovery process for the device based on the one or more parameters.

10. The device of claim 9, wherein the specified discovery process is the first discovery process for the device.

11. The device of claim 9, wherein:
the specified discovery process is the second discovery process for the second device;
the processor is further configured to predict a behavior of the second device based on the shared context, wherein the shared context is used by the second device in a preconfigured manner to determine the second discovery process; and
the one or more parameters of the first discovery process are determined by the device based on the predicted behavior of the second device.

12. The device of claim 9, wherein the shared context reduces randomness of determining at least one of a dwell time or a channel frequency in the specified discovery process, such that a likelihood of the specified discovery process being successful is increased.

13. The device of claim 9, wherein the shared context comprises at least one of:
an SSID of a Wi-Fi access point in a vicinity of the device and the second device;
a channel of the Wi-Fi access point in the vicinity of the device and the second device; and
a Bluetooth Low Energy (BLE) trigger transmitted by the device before the specified discovery process and containing a guaranteed Single Channel Publish (SCP) interval of the device.

14. The device of claim 9, wherein the shared context is provided by a common application executing on both the device and the second device.

15. The device of claim 14, wherein the shared context comprises at least one of:
one or more broadcast parameters of a local Wi-Fi network;
a seed for a random number generator; and
a cellular network time.

16. The device of claim 9, wherein the specified discovery process comprises a Neighbor Awareness Networking (NAN) Unxynchronized Service Discovery (USD) process.

17. A non-transitory computer readable medium comprising program code that, when executed by a processor of a device, causes the device to:
identify a shared context for a specified discovery process including at least one of a first discovery process for the device or a second discovery process for a second device;
determine one or more parameters of the first discovery process for the device based on the shared context; and
perform or resume the first discovery process for the device based on the one or more parameters.

18. The non-transitory computer readable medium of claim 17, wherein the specified discovery process is the first discovery process for the device.

19. The non-transitory computer readable medium of claim 17, wherein:
the specified discovery process is the second discovery process for the second device;
the program code further causes the device to predict a behavior of the second device based on the shared context, wherein the shared context is used by the second device in a preconfigured manner to determine the second discovery process; and
the one or more parameters of the first discovery process are determined by the device based on the predicted behavior of the second device.

20. The non-transitory computer readable medium of claim 17, wherein the shared context reduces randomness of determining at least one of a dwell time or a channel frequency in the specified discovery process, such that a likelihood of the specified discovery process being successful is increased.
